(19) United States
(12) Patent Application Publication
(10) Pub. No.: US 2022/0250405 A1
(43) Pub. Date: Aug. 11, 2022

(54) SECURITY INSERT WITH TACTILE VARNISH ARRANGEMENT FOR AN IDENTITY DOCUMENT, AND METHOD OF MAKING SUCH A SECURITY INSERT

(71) Applicant: Muehlbauer GmbH & Co. KG, RODING (DE)

(72) Inventor: Franz Hocherl, Rattiszell (DE)

(21) Appl. No.: 17/438,092

(22) PCT Filed: Mar. 10, 2020
(86) PCT No.: PCT/EP2020/056336

§ 371 Date: Sep. 10, 2021

(30) Foreign Application Priority Data
Mar. 12, 2019 (DE) 10 2019 002 160.6

(51) Int. Cl. B42D 25/387; B42D 25/328; B42D 25/45; B42D 25/29; B42D 25/41

(52) U.S. Cl. CPC B42D 25/387; B42D 25/328; B42D 25/41; B42D 25/29; B42D 25/45

(57) ABSTRACT

A security insert with at least one optically recognizable character and at least one tactilely detectable character for an identity document comprises at least a first at least partially transparent layer which has blackenings which form at least one optically recognizable character. A varnish arrangement forming at least one tactilely detectable character is disposed on a layer of the security insert. The at least one optically recognizable character is, at least from the perspective of an observer of the security insert, partially overlaid by the at least one tactilely detectable character, wherein at least a portion of the outer contours of the at least one tactilely detectable character is optically recognizably reproduced by the optically detectable character.

### CROSS-REFERENCE TO RELATED APPLICATIONS

This application is a National Stage application of International Application No. PCT/EP2020/056336 filed on Mar. 10, 2020 which claims priority to German Patent Application Serial No. DE 10 2019 002 160.6 filed Mar. 12, 2019.

### BACKGROUND

### Field

A security inlay with tactile lacquer arrangement for an identity document is described herein.

Such security inlays can be used, for example, in passports in the form of a data sheet, as well as in company ID cards, driver's licenses, identity cards, social security cards or membership cards.

### Discussion of the Related Art

A security insert is suitable for use both as part of a booklet, for example a passport, and as an identity document in credit card format, for example in accordance with ISO/IEC 7810.

Such security inserts are typically essentially rectangular in a plan view and comprise visually recognizable characters such as photographs of persons, text fields, ID numbers, national emblems and/or emblems. Tactile or haptically perceptible markings of security inserts are also known.

The objectives of the use of security inlays are the unique identifiability, durability, resistance and counterfeit resistance of the identity documents.

In order to increase the security against forgery, security inserts for identity documents may be provided with visible features which are difficult or at least very costly to imitate. These features serve to make it more difficult to forge the identity documents and/or to distinguish genuine identity documents from forged identity documents.

Furthermore, security inlays for identity documents may have invisible security features and/or security features that are only visible under certain conditions, for example under irradiation with UV light. These features also serve to make it more difficult to forge identity documents and/or to distinguish genuine identity documents from forged identity documents.

The German patent DE 10 2013 218 861 A1 discloses a semi-finished product for a security document, which under UV light illumination allows a graphic information to be recognized. However, the graphic information provides an optically recognizable security feature only under UV light illumination. For light in the visible wavelength range, the graphic information is transparent.

European patent EP 2 004 415 B1 shows the use of a laser engraving as a non-visible security feature for an identity document, but the document must be irreversibly destroyed to expose the laser engraving.

The document WO 2011/061 203 A1 relates to a value document with a transparent layer of plastic, which can have blackenings produced with laser light. In a welding area, the value document can also have a tactilely detectable security feature.

The document WO 2010/040 972 A1 relates to a security insert or security document which can have blackenings produced by means of laser light and various ink applications.

A method for producing blackenings in a substrate by means of laser light is also disclosed by document EP 187 028 A1.

Furthermore, it is desirable that a safety insert which has been modified by unauthorized persons can be detected as easily as possible by an observer, for example by inspection personnel, as a device which is not in its original state. This should be optimally detectable by the naked eye or verifiable by means of simple technical devices, for example infrared light illumination sources or UV light illumination sources. The absence of tactile or palpable (security) features of the security insert should also be as easy as possible to detect and at the same time not or only very difficult to conceal by further unauthorised changes to the security insert.

A weakness of known security inlays with tactile or palpable (security) features is that such features cannot easily be added to an existing security inlay by unauthorized persons without such a change in the security inlay being easily detected by control personnel. However, tactile or raised security features on the security inlay can usually be removed or scraped off comparatively easily with a sharp-edged object. If, in addition, the removed security features are personalized or merely optional security features of a security insert, their absence can usually not be detected by inspection personnel or at least only with difficulty without aids, since a mere absence of personalized or merely optional security features does not indicate that the integrity of the security insert has been compromised.

### SUMMARY

Despite existing solutions, there is still a need for an improved security insert for an identity document to avoid the disadvantages described.

It is therefore a task to provide an improved security insert for an identity document and a method for producing an improved security insert for an identity document. Unauthorized reproduction of the security insert by third parties should be made more difficult and the identity document should be able to be checked non-destructively for its integrity, in particular for the integrity of tactile security features, by means of optically recognizable signs.

This task solves a device according to claim 1, a method for manufacturing the device according to claim 6, and a manufacturing device according to claim 9. Advantageous embodiments are defined by the dependent claims.

A security insert for an identification document having at least one optically detectable character and at least one tactilely detectable character comprises at least a first at least partially transparent layer having blackenings forming at least one optically detectable character. The first at least partially transparent layer may be disposed in an interior of the security insert or may form an outer layer of the security insert. For example, the first at least partially transparent layer may be disposed between at least two other layers of the security insert or the first at least partially transparent layer may form a surface or exterior of the security insert.

At least in an undamaged state of the security insert, a lacquer arrangement is arranged on at least one layer of the security insert, which lacquer arrangement forms at least one tactilely detectable sign. The at least one optically detectable character is, at least from the perspective of an observer of the security insert, partially overlaid by the at least one tactilely detectable character, wherein at least part of the outer contours of the at least one tactilely detectable character is optically detectably reproduced by the optically detectable character.

In particular, if the lacquer arrangement has been at least partially removed from the security insert, for example by unauthorized third parties, at least part of the outer outlines of the at least partially removed tactilely detectable sign stands out visually perceptibly against the background of the optically detectable sign formed from blackenings.

The outer outlines of a tactilely detectable sign removed or not removed from the security insert, or parts of these outlines, can be distinguished by white lines or lines that stand out at least in comparison with their immediate surroundings, in particular lines that are lighter/brighter in comparison with their immediate surroundings, in the optically detectable sign formed by the blackenings, in particular in a greyscale image or greyscale sign formed by the blackenings.

In other words, the outer outlines of a distant or non-distant tactilely detectable character, or at least portions of those outlines, are visually detectable by a line-shaped brightness contrast in a grayscale image or gray-scale character formed by the redactions.

The outline of a remote or non-remote tactilely detectable character, or portions of such outline, may be detectable by an observer of the security insert when the security insert is illuminated with visible light and/or infrared light and/or UV light. Optionally, the coating arrangement may comprise a fabrication material comprising a UV phosphor.

An advantage over known devices is that the removal of individualized or merely optional tactile signs or security features from a security insert can also be easily detected, for example by inspection personnel. Since an irreversible or at least only with difficulty concealable optically recognizable change of the security insert is left also with a removal and/or a change or a replacement of the tactile signs or security features, on the one hand an anti-counterfeiting protection of the security insert can be further increased and on the other hand a verifiability of the integrity of the security insert can be further facilitated.

The at least one transparent layer may comprise a fabrication material of polycarbonate, polyethylene terephthalate, polyethylene terephthalate glycol, or polyvinyl chloride.

Advantages of manufacturing the safety insert or individual layers of the safety insert from polycarbonate, polyethylene terephthalate, polyethylene terephthalate glycol or polyvinyl chloride result, for example, from the resistance, lightness and flexibility of the materials.

Further, the at least one transparent layer may be blackenable by exposure to at least one beam of laser light, for example a beam of laser light having a wavelength of 1064 nm. For this purpose, the at least one transparent layer may comprise additives, in particular carbon-based additives. By the action of a beam of laser light, blackenings, in particular charring, can thus be selectively produced with a desired intensity.

One advantage of this is that it is difficult to remove and/or change the blackening inside a layer of the safety insert by means of a laser without destroying the safety insert.

Optionally, the safety insert may comprise further manufacturing elements, in particular further layers. In particular, the security insert may be a multilayer security insert comprising a plurality of layers bonded together, in particular by means of lamination. For example, the safety insert may comprise a second and/or a third at least partially transparent layer, each of which is blackenable by the action of laser light. Variants comprising further at least partially transparent layers that are blackenable by the action of laser light are also expressly possible. Likewise, variants comprising further transparent and/or non-transparent layers which are not blackenable by the action of laser light are expressly possible. The further transparent layers may each be bonded to the first at least partially transparent layer or to one of the further at least partially transparent layers, in particular by lamination.

One advantage of this is that a stack of layers, which has several interconnected layers, is difficult to disassemble into its individual layers without destroying them, so that, for example, it is considerably more difficult to change the safety insert by replacing a single layer.

At least one of the at least partially transparent layers may have an enlarged base area compared to another transparent layer, wherein base area means the dimensions of the security insert or individual transparent layers as seen by an observer of the security insert. The enlarged base area of the at least one at least partially transparent layer can advantageously serve to connect the security insert to a booklet, in particular a passport. In this case, that part of the at least one at least partially transparent layer which is enlarged relative to another transparent layer can be used for fastening the security insert in the booklet.

Optionally, one or more of the at least partially transparent layers may have a preformed background color application.

An advantage of using background colour applications is an efficient contribution to the overall visually perceptible information of the security insert. Furthermore, the background colour applications can contain security features which further increase the security of the security insert against counterfeiting.

Further, the security insert may optionally comprise a transparent cover layer, in particular a transparent cover layer made of polycarbonate, polyethylene terephthalate or polyethylene terephthalate glycol, disposed on one of the transparent layers, in particular on an outer one of the transparent layers.

One advantage of the cover layer is the protection of the safety insert against negative environmental influences such as moisture penetration or protection against mechanical damage such as scratching of the safety insert.

In one embodiment, the first transparent layer may be an outer surface of the security insert. In other words, in one embodiment, the first transparent layer may be an outermost layer of a security insert, wherein the lacquer arrangement may in particular be arranged on this outermost layer.

In further variants, the security inlay may comprise an opaque inlay layer, which is connected to at least one of the transparent layers, in particular by lamination, and/or a hologram element, which is arranged on one of the transparent layers and/or on the opaque inlay layer, and/or an arrangement of electronic components, in particular an antenna module and/or an RFID chip. This may further increase the counterfeit resistance of the security inlay and further improve a verifiability of the security inlay.

In one embodiment, the security insert may additionally comprise a color application disposed on one of the layers of the security insert. In particular, the ink application may comprise different color portions of cyan, magenta, and yellow, and in particular may be transparent to infrared light. For example, the ink application may be applied to the first transparent layer by means of ink jet printing.

An advantage of using the cyan, magenta and yellow colour components is that in one variant the use of black colour components for producing a colour image perceptible to the viewer of the security insert can be at least partially dispensed with, without the available colour spectrum being restricted as a result. Those black components of an overall image which are required in printing processes known as prior art (cyan-magenta-yellow-black printing process, CMYK printing process, in accordance with ISO 2846) for producing a true-colour overall image can be formed by the blackenings in at least one of the layers. In this way, the use of black ink components in the ink application can be at least partially dispensed with.

In other words, the application of paint in cooperation with the at least one optically recognizable character formed by the blackenings can produce an optically perceptible overall image, in particular a colored portrait of a person. The application of paint may partially or completely cover the blackenings in the transparent layer(s) or the at least one optically recognizable character. The paint application may be disposed on the first transparent layer. The paint application may form an outermost layer of the security insert. The ink application may be arranged on the outer side of the outermost layer of the security insert.

In one embodiment, which may be combined with any or all of the other features disclosed herein, the paint application is located on the exterior of the security insert, and the paint arrangement is located directly on the paint application. In this case, the blackenings are located in the first transparent layer which is arranged inside the security insert.

Further, by combining the color components of cyan, magenta and yellow, an additional, in particular, colored black color coating can be formed which is transparent, in particular, to infrared light.

Thus, the outer outlines of a distant or non-distant tactilely detectable character can be detected as a line-shaped brightness contrast in the at least one gray-scale image or gray-scale character formed by the blackenings, in particular even if the optically detectable character formed by the blackenings is completely obscured by the paint application, for example a paint application that is opaque to visible light and in particular a paint application with colored black color components. In this case, it is sufficient to illuminate the security insert with infrared light for inspection in order to check the integrity of the security insert.

In one embodiment, the security insert may further comprise a first UV ink coating located on a layer of the security insert, for example on the first at least partially transparent layer, and/or on the ink coating. The first UV ink application may reflect at least UV light in a first wavelength range. Thus, additional optically detectable indicia may be formed by the first UV ink application.

In a further embodiment, the security insert may further comprise a second UV ink coating located on a layer of the security insert and/or on the ink coating and/or on the first UV ink coating. The second UV ink application may reflect at least UV light in a second wavelength range. Thus, further additional optically detectable indicia may be formed by the second UV ink application.

The first UV ink coating and/or the second UV ink coating may be transparent to visible light and/or infrared light.

In one embodiment, the first UV ink application and/or the second UV ink application may be multicolor UV ink applications. In particular, the UV ink applications may comprise color components of red, green, blue and white (RGBW) or of cyan, magenta, yellow and/or black (CMYK), each of which reflects UV light. The use of further color components for the first and/or for the second UV color application is possible in a further development.

The first UV color application and/or the second UV color application may be arranged and configured to display to a viewer of the security insert during irradiation of the security insert with UV light a multicolored graphic information, for example a facial image of the badge holder, which is not visible to the viewer, in particular during irradiation of the security insert with exclusively visible light.

In one embodiment, the first and/or second UV color application may be bi-fluorescent. In particular, the first UV color application may provide a first color impression to a viewer of the security insert during irradiation of the security insert with UV light of a first wavelength and may provide a second color impression during irradiation of the security insert with UV light of a third wavelength. Further, the second UV color application may provide a third color impression to a viewer of the safety insert during irradiation of the safety insert with UV light of a second wavelength, and may provide a fourth color impression during irradiation of the safety insert with UV light of a fourth wavelength. The first, second, third and fourth color impressions may each be different from one another or at least partially identical.

For example, during irradiation of the safety insert with UV light of a first wavelength of preferably 365 nm, the first UV color application may provide the viewer of the safety insert with a color impression comprising red, green, blue, and white color components, and during irradiation of the safety insert with UV light of a third wavelength of preferably 254 nm, the first UV color application may provide the viewer of the safety insert with a color impression comprising green and red color components.

In another example, the second UV color application may provide a blue color impression to a viewer of the security insert during irradiation of the security insert with UV light of a second wavelength, preferably 365 nm, and may provide a red color impression during irradiation of the security insert with UV light of a fourth wavelength, preferably 313 nm.

An advantage of the first UV ink application and/or the second UV ink application is that further security features can be added to the security insert, which become visible when the security insert is irradiated with UV light. If both a first UV ink application and a second UV ink application are used, each of which reflects UV light in different wavelength ranges, this enables a further increase in the counterfeit protection of the security insert, in particular because a replication of the security insert is made even more difficult.

The ink application and/or the first UV ink application and/or the second UV ink application may comprise a solvent-containing ink, in particular a pigment-based ink and/or an ink that can be cured by means of UV light, which ink is suitable for dissolving and/or at least partially penetrating a surface of polycarbonate or polyethylene terephthalate during an application process.

An advantage of using such solvent-based inks to form the ink application is an increase in the tamper resistance of the security inlays. For example, it is more difficult to remove the ink application from the first transparent layer, for example for the purpose of replacing the first ink application by an unauthorized third party.

The ink application and/or the first UV ink application and/or the second UV ink application may comprise forensic markers, in particular silicon, silicon dioxide, mica, titanium oxide and/or tin oxide.

One advantage of using such forensic markers is the ability to verify the integrity of a security insert. Although such forensic markers are typically not visible to the naked eye, a targeted examination of the security insert using the forensic markers can determine whether it is an original document or a forgery.

Both the ink application and the first UV ink application and the second UV ink application are (ink) layers of the security insert within the meaning of the present disclosure, on which, in particular, the coating arrangement may also be arranged. The ink application and/or the first UV ink application and/or the second UV ink application may further each form an outer layer or an outer side of the security insert.

The at least one tactilely detectable character may form the outer contours of textual information or pictorial information, in particular a portrait of a person, a national emblem or a coat of arms. Also, the at least one tactilely detectable character may form a logo, a sequence of digits, circular knobs, stars, hearts, and rectangular or round/oval surfaces.

In one embodiment, the outer contours of the at least one tactilely detectable character may reflect information associated with a holder of the security device. For example, biometricinformation and/or a passport or ID card number associated with the holder of the security device may be partially or fully reflected/formed by the outer contours of the at least one tactilely detectable character.

Furthermore, the varnish arrangement may comprise a UV-curable manufacturing material. An advantage here is that the varnish arrangement can optionally be cured together with a UV light curable ink application or UV ink application.

The varnish arrangement may comprise a plurality of spaced apart tactile varnish applications, which may be of the same or different design to each other.

Further, the varnish arrangement may comprise at least one tactile varnish application that is transparent to visible light and/or to infra-red light and/or UV light, such that the at least one tactile varnish application in particular does not optically hide the at least one optically recognizable character from an observer. Also, the entire lacquer arrangement may be transparent to visible light and/or to infrared light and/or UV light.

The paint arrangement may comprise at least one tactile transparent paint coating having a higher optical density than an atmosphere surrounding the security insert. In other words, the optical refractive index of a tactile transparent varnish application may be greater than the optical refractive index of the (ambient) air surrounding the security insert. For example, in one embodiment, the optical refractive index of a transparent varnish application may be greater than 1,100. In particular, the optical refractive index of a transparent lacquer coating may be greater than 1,300. In one embodiment, a transparent resist insert may have an optical refractive index of about 1.585.

Further, the varnish arrangement may include at least one tactile transparent varnish layer having a lower optical density than one or more of the at least partially transparent layers.

In one embodiment, the lacquer arrangement may have at least one tactile lacquer application that has an at least partially rounded cross-section, in particular a partially lenticular or semi-elliptical cross-section. In particular, a tactile trans paren t varnish application may form a half-lens shape, in particular a half-collection lens shape, on one of the layers of the security insert in a cross-section.

The lacquer arrangement may comprise at least one tactile lacquer application which is designed and arranged to optically refract light directed at least substantially perpendicularly to the safety insert, in particular laser light directed at least substantially perpendicularly to the safety insert. In other words, the at least one tactile varnish application may be adapted to modify the beam path of incident (laser) light by means of optical refraction. In particular, the at least one tactile varnish application may be arranged to refract or deflect incident light, in particular light incident at least substantially perpendicularly to the security insert, at an angle towards a surface normal of a surface of the security insert or towards a surface normal of one of the layers of the security insert.

An advantage here is that laser light incident in particular at the edges or outer contours of the lacquer applications, with which blackening can be introduced into the at least one transparent layer below the lacquer arrangement, is refracted and/or reflected. The portions of the transparent layer located in the direction of the incident laser light immediately below the edges or outer contours of the lacquer orders are thus blackened to a lesser extent than would be the case if the laser light were to impinge unhindered on the transparent layer. In other words, the optically recognizable character or gray scale image introduced into the at least one transparent layer by means of laser light may exhibit a contrast distortion in the region of the edges or the outer contours of the lacquer applications due to the refractive and/or reflective properties of the lacquer applications.

However, in some embodiments, the comparatively less blackened portions of the at least one transparent layer or the line-shaped contrast distortions of the optically recognizable character or the grayscale image in the area of the edges or outer contours of the varnish applications may be only perceptible to a viewer of the security insert to a reduced extent. At least as long as the varnish arrangement has not been at least partially removed from the security insert, the view of the viewer of the security insert follows the same optical beam path through the varnish applications as the laser beam for producing the blackenings. Thus, in some embodiments, the contrast distortion of the at least one optical character or grayscale image caused by the refractive and/or reflective properties of the varnish application may be at least partially optically corrected again for a viewer of the security insert by the refractive and/or reflective properties of the same varnish application.

However, if at least that part of the lacquer arrangement is subsequently removed which overlays the blackenings in the at least one transparent layer or the at least one optically detectable mark, comparatively light lines against the background of the blackenings, which follow the edges or the outer contours of the removed lacquer applications, become visible to an observer of the security insert. A subsequent change to a tactilely detectable character of a manufactured security insert can thus be easily understood, even if the tactilely detectable character is personalized information or merely an optional security feature.

The varnish arrangement may further comprise a plurality of tactile varnish applications that together form a relief structure on one of the layers of the security insert, wherein the relief depth of the relief structure is less than a respective distance between the tactile varnish applications.

Further, the lacquer arrangement may comprise a plurality of tactile lacquer applications, wherein the respective distance between the tactile lacquer applications may be greater than a diameter of the lacquer applications. The diameter of a lacquer application is defined here as the minimum extension of a lacquer application in a direction orthogonal to a surface normal of a layer of the security insert.

The plurality of tactilely detectable paint jobs may be spaced apart from each other by both regular and irregular distances. In other words, the plurality of tactilely detectable paint jobs may be spaced apart from each other by a uniform distance or may be spaced apart from each other by different distances.

A method of producing a security insert for an identity document having at least one visually detectable character and at least one tactilely detectable character includes the steps of:
providing at least a first at least partially transparent layer;
disposing a lacquer arrangement on a layer of the security insert so that the lacquer arrangement forms at least one tactilely detectable mark;
creating at least one optically detectable character partially overlying said at least one tactilely detectable character by blackening said at least one partially transparent layer by means of a beam of laser light, wherein said paint arrangement refracts said beam of laser light at least in an edge region of said tactilely detectable character overlying said optically detectable character.

In particular, the varnish arrangement may refract the beam of laser light with a positive refractive power at least in an edge region of the tactile detectable character overlying the optically detectable character.

It will be understood that the method disclosed herein necessarily requires the production of the at least one tactilely detectable character prior to the production of the at least one optically detectable character.

Optionally, the method may further comprise at least one of the following steps, wherein the additional manufacturing steps may be performed at any point in the method
providing a second and/or third transparent layer;
providing a cover layer and/or an opaque inlay layer;
providing a hologram element and/or an array of electronic components;
bonding the layers and/or hologram elements and/or electronic component assemblies of the security insert, in particular by a lamination process;
application of an ink coating which forms an overall image with the at least one optically recognizable character;
application of a first UV ink coat;
application of a second UV ink coat;
drying/curing of the varnish assembly with UV light;
drying/curing of the ink application and/or the first UV ink application and/or the second UV ink application by means of UV light.

The order in which the procedural steps are carried out is not dictated by the order in which they are mentioned.

The application of the paint and/or the arrangement of the paint arrangement may each be carried out by a printing process, for example by a drop-on-demand process. In particular, the paint application may be applied to one of the layers of the security insert before the paint arrangement. In other words, the paint arrangement may be arranged at least partially on the paint application.

In a further development, both the application of the paint and the arrangement of the paint arrangement can be carried out by a combination device suitable for this purpose. For example, a layer of paint can first be applied to a layer of the safety insert and then, after it has at least partially dried, a paint arrangement can be arranged on the layer of paint. The drying/curing of the paint layer and the paint arrangement can also be carried out by a combination device suitable for this purpose. Of course, the first and/or the second UV ink application can also be applied and/or dried/cured together with the ink application and/or the varnish application.

An advantage of a combination device, which is designed to arrange/apply an ink application and/or a UV ink application and/or a varnish arrangement, is an increased efficiency of the manufacturing process and thus a reduction in manufacturing costs.

In a process variant, an already prefabricated arrangement of interconnected, in particular interlaminated, layers can be provided, wherein the interconnected layers comprise at least a first at least partially transparent layer which can be blackened by means of laser light. Optionally, a paint application and subsequently a lacquer arrangement may be applied to said prefabricated arrangement. In this case, the paint application and the paint arrangement can each be dried, separately or together, in particular by means of irradiation with UV light. Subsequently, by means of irradiation of the interconnected layers with a beam of laser light, blackenings can be produced in at least one of the interconnected layers. In particular, the blackenings may be produced in an interior of the array of interconnected layers, in particular inter-laminated layers. The blackenings may form an overall image, in particular a coloured portrait of a person, together with the ink application.

A device for manufacturing a security insert for an identity document, as described above, comprises a handling device arranged and configured to fix a security insert or parts of a security insert and to convey it along a processing path. Further, the manufacturing device comprises a varnish application device, in particular a printer, arranged and adapted to arrange a varnish application on a layer of the conveyed security insert such that the varnish application forms at least one tactilely detectable mark. A laser device is further arranged and configured to produce blackenings in at least a first at least partially transparent layer of the conveyed security insert by means of a beam of laser light, such that at least one optically recognizable character is produced which is partially overlaid by the at least one tactilely detectable character, wherein the beam of laser light is optically refracted and/or partially reflected by the varnish application at least in an edge region of the tactilely detectable character overlaying the optically recognizable character to be produced during the production of the security insert.

A printing device, which in a further embodiment may be formed in common with the paint application device, may further be arranged and configured to apply an application of paint to a layer of the conveyed security insert.

Optionally, the manufacturing apparatus may further comprise a first UV curing device arranged and configured to cure the coating application applied to a layer of the conveyed security liner by means of UV light and/or a second UV curing device arranged and configured to cure the ink application applied to a layer of the conveyed security liner by means of UV light. In a further embodiment, the first and second UV curing devices may be formed as a common device.

Further, a lamination device may be arranged and configured to bond two or more layers of the security insert together.

It will be apparent to those skilled in the art that the aspects and features previously described may be combined in any desired manner.

### BRIEF DESCRIPTION OF THE DRAWINGS

Further features, characteristics, advantages and possible variations will become clear to a person skilled in the art from the following description, in which reference is made to the accompanying drawings. In this respect, the figures schematically and exemplarily show in each case a security insert for an identity document or a part of such a security insert. In this regard, all of the described and/or pictorially depicted features, individually or in any combination, illustrate the subject matter disclosed herein. The dimensions and proportions of the components shown in the figures are not to scale.

FIG. 1 shows schematically and by way of example a security insert for an identity document in a top view and a cross-sectional view of the security insert.

FIGS. 2 and 3 each show schematically and by way of example a possible layered structure of a security insert for an identity document in a cross-sectional view.

FIGS. 4 and 5 each show schematically and exemplarily a security insert for an identity document in a top view and a cross-sectional view of the security insert, wherein the visibility of a part of the outline of a tactilely detectable character removed from the security insert is illustrated against the background of the blackenings in at least one of the transparent layers.

FIGS. 6 and 7 each show a schematic example of a further security insert for an identity document in a top view and a cross-sectional view. The security insert shown has a tactilely detectable sign that reproduces text information.

### DETAILED DESCRIPTION OF THE EMBODIMENTS

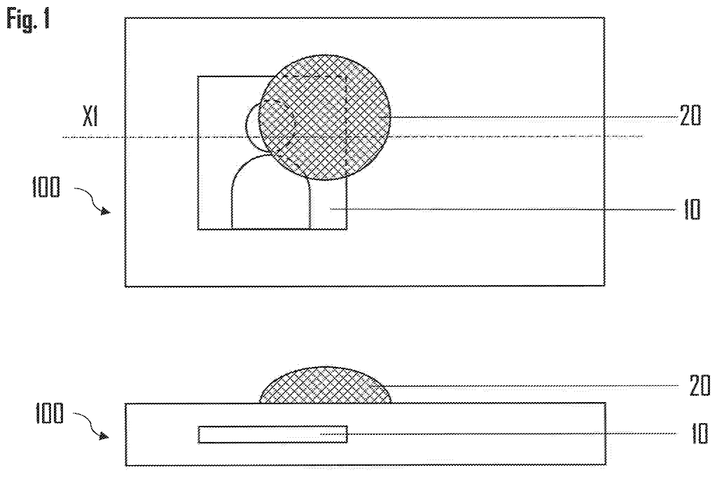

FIG. 1 shows an exemplary and schematically simplified view of a safety insert 100 with a visually detectable sign 10 and a tactilely detectable sign 20 in a top view and a cross-sectional view of the safety insert 100.

For reasons of overview, FIG. 1 shows only one optically recognizable character 10 and one tactilely detectable character 20, although any other embodiments with any number of optically recognizable characters and tactilely detectable characters are of course possible.

In the example shown, the tactilely detectable sign 20, which is circular in plan view and is formed by an application of varnish to the safety insert 100, is partially superimposed on the visually detectable sign 10.

In the example shown, the optically recognizable sign 10 shown only schematically in FIG. 1 is a rectangular grayscale portrait of a person, which shows the head and the upper body of a person against a background that is at least not pure white. The greyscale portrait of a person is formed by blackenings produced with a laser beam in at least one layer of the security inlay.

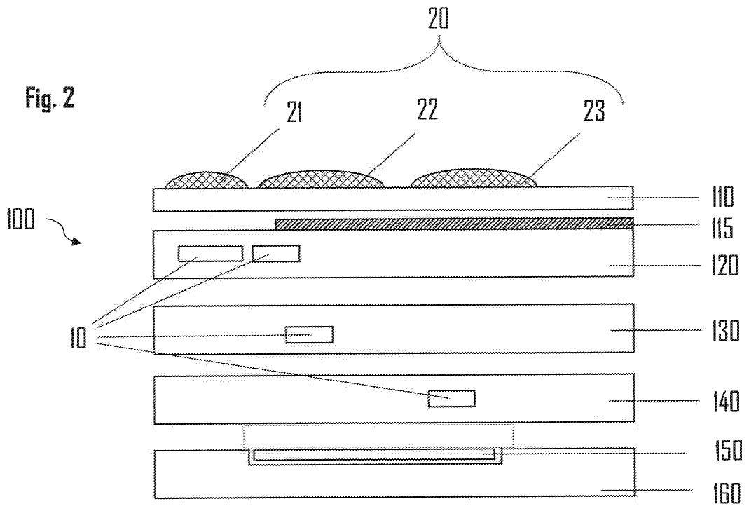

FIG. 1 shows only a highly simplified cross-sectional view of the safety insert 100 with the optically detectable character 10 and the tactilely detectable character 20. However, an example of a possible structure of the safety insert 100 is described in more detail with reference to FIG. 2.

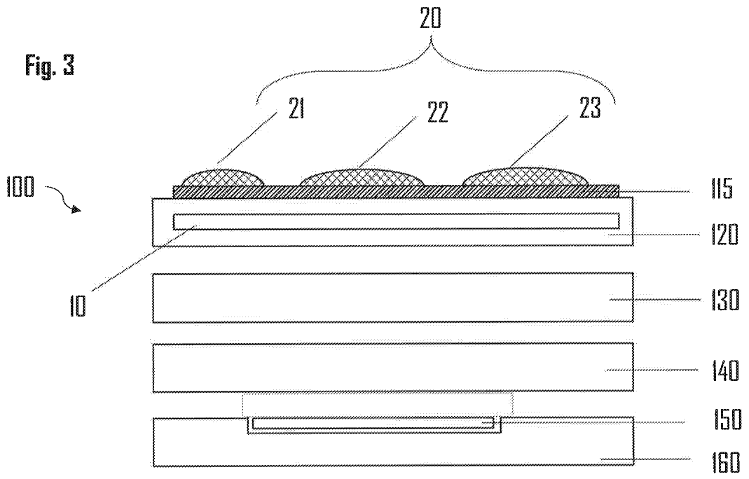

In particular, a safety insert 100 may comprise several layers arranged one above the other and connected to each other, as shown in FIG. 2 and FIG. 3. Merely for reasons of clarity, the interconnected layers are shown here as device elements spaced apart from one another.

The security insert shown in a cross-sectional view in FIG. 2 includes a transparent cover layer 110, as well as a first transparent layer 120, a second transparent layer 130, a third transparent layer 140, a hologram element 150, and an opaque inlay layer 160. The hologram element 150 is received in a correspondingly shaped recess of the inlay layer 160 and is enclosed by the inlay layer 160 and the third transparent layer 130.

Said layers 110, 120, 130, 140, 160 are connected to each other by a lamination process. Both the first transparent layer 120 and the second and third transparent layers 130, 140 each have blackenings produced by the action of laser light, which form a sign 10 or a grey-scale image that is optically perceptible to the viewer of the security insert.

On the transparent cover layer 110 (in contrast to the examples shown in FIG. 1 or FIGS. 3 to 6), a lacquer arrangement with three spaced lacquer applications 21, 22, 23 is arranged, which together form the tactilely perceptible sign 20 that partially overlays the optically perceptible sign 10 from the perspective of an observer.

Further, an ink layer 115 transparent to infrared light is disposed/printed on the first transparent layer 120 and includes color components of cyan, magenta, and yellow and forms an overall image with at least a portion of the first optically detectable character 10.

FIG. 3 illustrates another example of a security insert 100. The security insert shown in a cross-sectional view in FIG. 3 includes a first transparent layer 120, a second transparent layer 130, a third transparent layer 140, a hologram element 150, and an opaque inlay layer 160. The hologram element 150 is received in a correspondingly shaped recess of the inlay layer 160 and is enclosed by the inlay layer 160 and the third transparent layer 130.

Said layers 120, 130, 140, 160 are bonded together by a lamination process. In a departure from the example shown in FIG. 2, only one of the layers (the first transparent layer 120) has blackenings produced by the action of laser light, which form a mark 10 or a greyscale image that is optically perceptible to the viewer of the security insert.

An ink layer 115 that is transparent to infrared light is disposed/printed on the first transparent layer 120 and includes color components of cyan, magenta, and yellow. In the example shown in FIG. 3, the ink application or ink layer 115 and the blackenings together form an overall image. In this case, the ink application 115 and the blackenings each convey the same optical information to a viewer of the security insert, namely once as a gray-scale image (due to the blackenings) and once as a color image (due to the ink application), with the gray-scale image and the color image complementing/overlapping one another to form the overall image.

In a departure from the example shown in FIG. 2, the security insert 100 shown in FIG. 3 does not have a cover layer. In the example shown in FIG. 3, the spaced apart paint applications 21, 22, 23 forming the paint arrangement 20 are arranged directly on the paint application or paint layer 115. In the example shown, a portion of the paint application or paint layer 115 is overlaid/covered by the paint applications 21, 22, 23, while another portion of the paint application or paint layer 115 is not overlaid/covered by the paint applications 21, 22, 23. Further, from the perspective of an observer of the security insert, the paint applications 21, 22, 23 also partially overlay the blackenings that form the visually perceptible mark 10.

The safety inserts shown in FIG. 2 and FIG. 3 are only examples of embodiments. Other embodiments of the safety insert may, for example, have more or fewer layers than the safety inserts shown in FIGS. 2 and 3 and/or other arrangement constellations of the device elements shown in FIGS. 2 and 3.

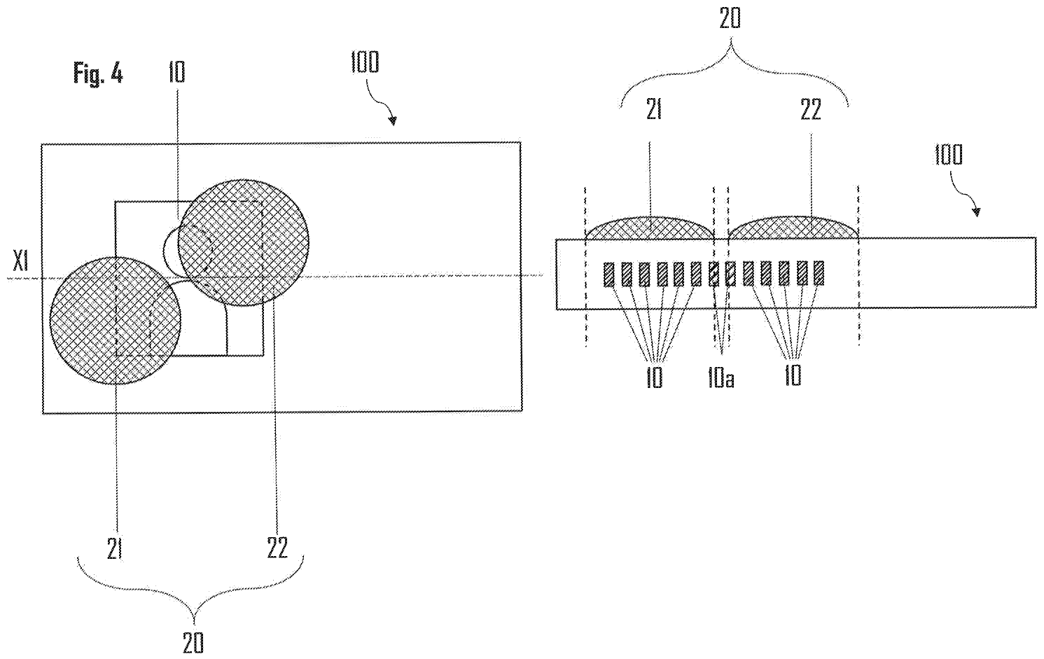

FIG. 4 shows, by way of example and in schematically simplified form, a further example of a safety insert 100 with a visually detectable character 10 and a tactilely detectable character 20 in a plan view and in a cross-sectional view along the sectional axis X1. The simplified representation of the safety insert 100 in the cross-sectional view is here also representative of multilayer safety inserts, as shown in FIG. 2 and FIG. 3, wherein the blackenings shown in FIG. 4 in only schematically simplified form, which form the optically detectable character 10, 10a , can be located in different transparent layers of the safety insert.

FIG. 4 shows an example of a security insert for an identity document having an optically detectable character 10, which in the example shown (analogous to the example shown in FIG. 1) is a rectangular greyscale portrait of a person showing the head and upper body of a person against a background which is at least not pure white. The visually detectable character is partially covered by two spaced apart paint applications 21, 22 which together form the tactilely detectable character 20 on the surface or outer surface of the security insert 100.

As shown in the simplified cross-sectional view of the security insert 100, the blackenings located below the outer contours or edge portions of the paint applications 21, 22 formed in a substantially semi-elliptical shape in a cross-section have a lower blackening intensity than the blackenings surrounding each of them. In other words, the portions 10a of the optically recognizable sign or the gray-scale person portrait which are located below the edges or outer outlines of the varnish applications from the perspective of an observer are slightly blackened than the portions 10 of the optically recognizable sign or the gray-scale person portrait surrounding them.

The comparatively less pronounced or less intensive blackening of the at least one transparent layer below the edges or below the outer contours of the lacquer applications 21, 22 is due to the fact that the blackenings are produced only after the lacquer arrangement 20 has been applied to the security insert 100 by means of irradiation of the security insert, in particular of the at least one transparent layer, with laser light. In particular, a portion of the incoming laser light for producing the blackenings is reflected and/or refracted or deflected by the rounded edges of the lacquer applications. Thus, only a reduced amount of laser light reaches the portions of the transparent layers lying below the edges or outer contours of the varnish applications 21, 22, while the portions of the transparent layers not lying below the rounded edges or outer contours of the varnish applications are not or hardly affected during the production of the blackenings by means of laser light.

The laser light deflected or refracted by the edges or outer contours of the resist applications 21, 22 further enhances the contrast between the comparatively less blackened portions 10a and the surrounding portions 10 of the optically recognizable character or gray scale person portrait, in that the refracted or deflected laser light in its beam path further enhances the blackening of the portions 10 of the optically recognizable character or gray scale person portrait which are not below the edges or outer contours of the resist applications 21, 22. The laser light deflected in its beam path additionally contributes to the blackening of the portions 10 of the optically recognizable sign or the gray scale person portrait, respectively, which are not positioned below the edges or the outer contours of the lacquer coatings 21, 22, respectively.

In summary, from the perspective of an observer, the blackenings located below the outer outlines or below the edges of the paint applications 21, 22 form at least one contrast stripe 10a or contrast zone extending through the optically recognizable sign or gray scale person portrait 10, which contrast stripe 10a or contrast zone is silhouetted against the background of the optically recognizable sign or gray scale person portrait 10.

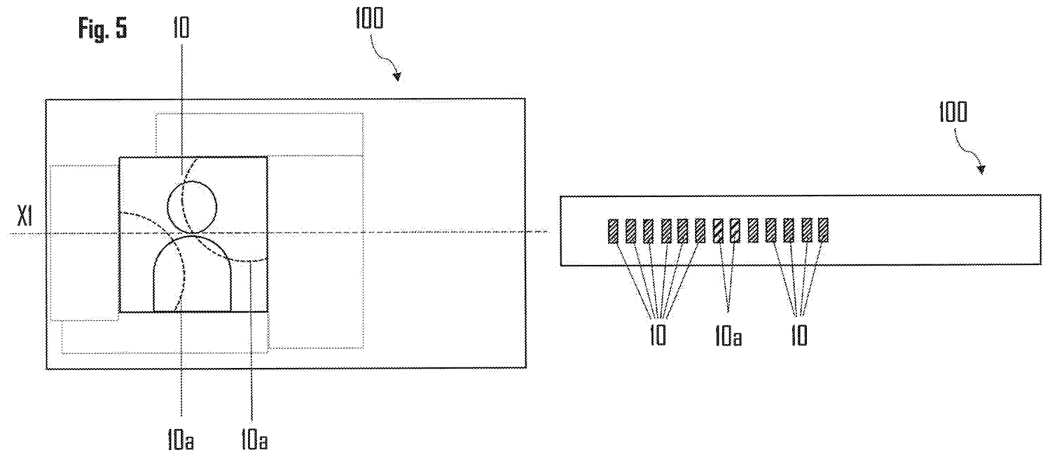

FIG. 5 shows the arrangement already shown in FIG. 4, the lacquer arrangement 20 having been subsequently removed from the security insert 100, for example in an attempt at counterfeiting. Despite the removal of the varnish arrangement 20, the outer outlines or edges of the varnish applications 21, 22 stand out against the background of the visually discernible character or greyscale person portrait 10 as comparatively bright linear contrasting stripes 10a.

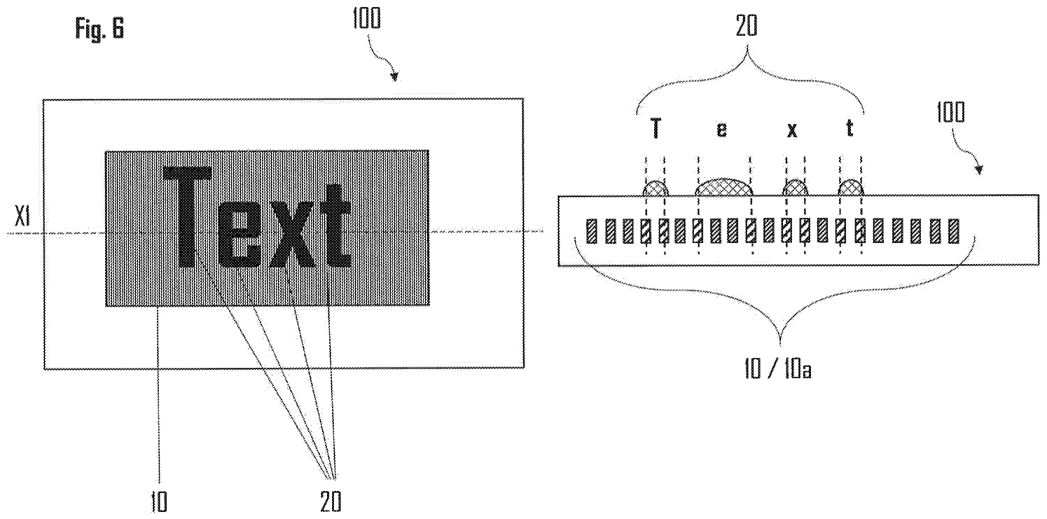

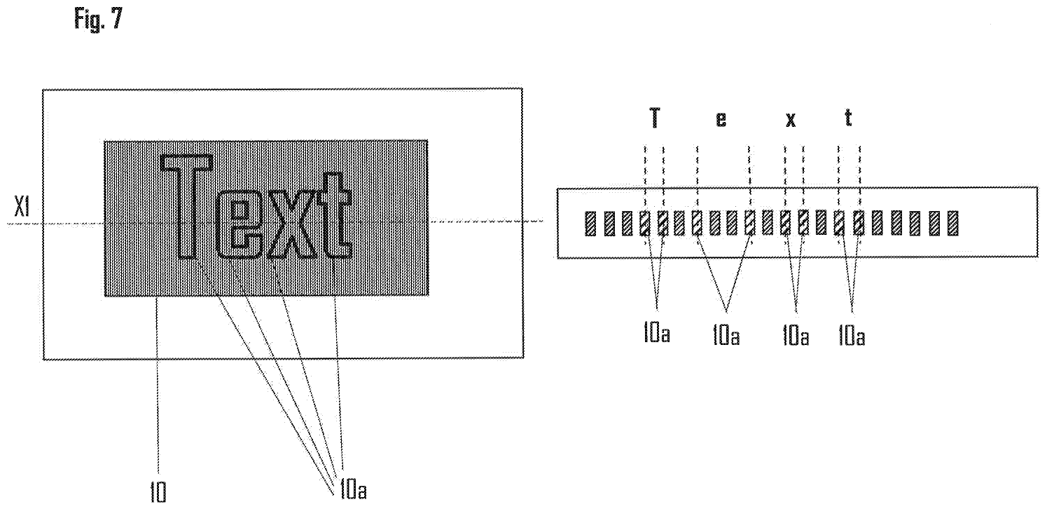

FIG. 6 and FIG. 7 are meant for further clarification. These also show a top view of an example of a safety insert 100, as well as a schematized cross-sectional view of the safety insert 100 along the cut axis X1.

In the embodiment shown therein, the first optically detectable character 10 is a rectangular background hatching of a security insert 100 formed by blackenings in at least one of the transparent layers of the security insert. The first optically recognizable character 10 (or the background hatching) is partially overlaid by a varnish application 20, which forms a tactilely detectable character in the form of text information. The individual letters of the text information are formed by spaced apart applications of varnish.

As already explained with respect to FIG. 4, during the manufacture of the article shown in FIG. 6, the lacquer arrangement 20 was first applied to the security insert 100. Subsequently, the optically recognizable character 10, in the example shown the background hatching, was produced by means of blackening or charring caused by laser light in at least one of the transparent layers of the security insert. Due to the reflective and refractive properties of the edges of the spaced apart paint applications, at least for substantially vertically incident laser light, an intensity of the blackenings 10a below the edges of the paint applications disposed on the security insert 100 is reduced relative to the remaining blackened areas of the first optically recognizable character 10, in the example shown relative to the background hatching.

As is illustrated with reference to FIG. 7, these blackenings, which are reduced in intensity along the edges of the varnish applications, are optically perceptible in particular even if the varnish arrangement 20 has subsequently been removed from the security insert 100.

The tactilely detectable mark 20 from the variants described above may also be generated by printing the varnish application in a planar and overlapping manner with the optical mark 10 (in the manner described above). In this case, the varnish may have one or more depressions/elevations in the area of the varnish application, so that the thickness of the varnish is lower/higher there. For example, this is achieved by an embossing stamp or a cliché. By selectively structuring the depressions/elevations, a coat of arms, a logo, a combination of letters and/or numerals, etc. can be embossed. As with the individual lacquer jobs 21, 22, 23, the depressions/elevations also have outer contours which are reproduced by the optical character 10. This is achieved by lasering through the varnish in the area of the depressions/elevations or outlines into the card material. This variation works in combination with the paint application 115 or in combination with the laser image only.

In the variants explained above, the optical sign 10 appears immobile to an observer when the card is tilted; it does not provide a viewing angle dependent effect.

It is understood that the exemplary embodiments previously explained are not exhaustive and do not limit the subject matter disclosed herein. In particular, it will be apparent to those skilled in the art that they may combine the features described as desired and/or omit various features without departing from the subject matter disclosed herein.

1. A security insert with at least one visually detectable sign and at least one tactilely detectable sign for an identity document, comprising:
at least a first at least partially transparent layer having blackenings which form at least one optically detectable sign and which reflect infrared light and visible light and/or UV light,
an application of paint which
(i) is disposed on a layer of the security insert and
(ii) reflects visible light, and
(iii) is transparent to infrared light and/or to UV light,
a lacquer arrangement which is arranged on a layer of the security insert and which forms at least one tactilely detectable sign and which is transparent to visible light and infrared light and/or UV light wherein
the at least one optically detectable sign is partially overlaid by the at least one tactilely detectable sign, and wherein
at least a part of the outer contours of the at least one tactilely detectable sign is reproduced in an optically detectable manner by the optically detectable sign,
characterized in that
the colour application forms an optically perceptible overall image with the at least one optically perceptible character formed by the blackenings in at least one of the transparent layers.

2. The security insert according to claim 1, wherein the at least one transparent layer comprises a manufacturing material of polycarbonate polyethylene terephthalate, polyethylene terephthalate glycol or polyvinyl chloride, and/or
the at least one transparent layer is to be blackened by the action of at least one beam of laser light the blackenings are designed to reflect infrared light and/or visible light and/or UV light.

3. The security insert according to claim 1, further comprising:
a second and/or third at least partially transparent layer which can be blackened by the action of laser light and/or which are bonded to the first transparent layer, in particular by lamination, and/or
a cover layer disposed on one of the transparent layers, in particular on an outer one of the transparent layers, and/or
an opaque inlay layer which is bonded to at least one of the transparent layers, in particular by lamination, and/or
a hologram element disposed on one of the transparent layers and/or on the opaque inlay layer, and/or
an arrangement of electronic components, in particular an antenna module and/or an RFID chip.

4. The security insert according to claim 3, wherein
the ink application comprises different colour portions of cyan, magenta and yellow; and/or
the overall picture is a coloured portrait of a person; and/or
the ink coating is arranged on the first transparent layer; and/or
the ink application forms an outermost layer of the security liner; and/or
the ink application is disposed on the outside of the outermost layer of the security liner;
the ink application comprises a solvent-containing ink, in particular pigment-based ink and/or ink curable by means of UV light, which is suitable for dissolving and/or at least partially penetrating a surface of polycarbonate or polyethylene terephthalate during an application process; and/or
the paint application comprises forensic markers, in particular silicon, silicon dioxide, mica, titanium oxide and/or tin oxide.

5. The security insert according to claim 1, wherein
the at least one tactilely detectable sign forms the outer contours of textual information or pictorial information, in particular a portrait of a person, a national emblem or a coat of arms, and/or
the lacquer arrangement comprises a production material which can be cured by means of UV light, and/or
the lacquer arrangement comprises a plurality of tactile lacquer applications spaced apart from one another, and/or the lacquer arrangement has at least one tactile lacquer application which is transparent to visible light and/or to infrared light and/or to UV light, and/or
the lacquer arrangement has at least one tactile lacquer layer which has a higher optical density than an atmosphere surrounding the safety insert and/or has a lower optical density than one or more of the at least partially transparent layers, and/or
the lacquer arrangement has at least one tactile lacquer application which has an at least partially rounded, in particular a partially lenticular, cross-section, and/or
the lacquer arrangement has at least one tactile lacquer coating which is designed and set up to refract light directed at least substantially perpendicularly to the safety insert, in particular laser light directed at least substantially perpendicularly to the safety insert, and/or
the lacquer arrangement comprises a plurality of tactile lacquer applications which together form a relief structure on one of the layers of the security inlay, the relief depth of the relief structure being less than a respective spacing of the tactile lacquer applications from one another, and/or
the lacquer arrangement has a plurality of tactile lacquer applications, the respective distance between the tactile lacquer applications being greater than a cross-sectional diameter of the respective lacquer applications.

6. The security insert according to claim 5, wherein
the plurality of spaced apart tactile paint applications are disposed directly on the paint application, and
the plurality of spaced apart tactile paint applications partially overlay the paint application, and
at least a portion of the paint application is not overlaid by the plurality of spaced apart tactile paint applications.

7. A method for manufacturing a security insert having at least one visually detectable mark and at least one tactilely detectable mark for an identification document, comprising the steps of:
providing at least a first at least partially transparent layer;
arrangement of a varnish arrangement on a layer of the security insert which forms at least one tactilely detectable sign and which is transparent to visible light and infrared light and/or UV light;
producing at least one optically detectable sign at least partially overlaid by said at least one tactilely detectable sign by blackening said at least one partially transparent layer by means of a beam of laser light, said blackenings reflecting infrared light and visible light and/or ultraviolet light; and wherein
the varnish arrangement refracts the beam of laser light at least in an edge region of the tactilely detectable sign overlaying the optically detectable sign; and
application of a paint coating which reflects visible light and which is transparent to infrared light and/or to UV light to a layer of the security insert;
characterized in that
the colour application forms an optically perceptible overall image with the at least one optically perceptible character formed by the blackenings in at least one of the transparent layers.

8. The method according to claim 7, wherein
the varnish arrangement refracts the beam of laser light with a positive refractive power at least in an edge region of the tactilely detectable character superimposed on the optically detectable character.

9. The method of claim 7, further comprising at least one of the steps:
providing a second and/or third transparent layer;
providing a cover layer and/or an opaque inlay layer;
providing a hologram element and/or arrangement of electronic components; and
bonding the layers and/or hologram elements and/or electronic component assemblies of the security insert.

10. An apparatus for producing a security insert for an identity document, comprising:
a handling device arranged and configured to fix and convey along a processing path a security insert or parts of a security insert,
a varnish application device which is arranged and designed to arrange a varnish application transparent to visible light and to infrared light and/or to UV light on a layer of the conveyed security insert, so that the varnish application forms at least one tactilely detectable sign,
a laser device arranged and adapted to produce blackenings in at least a first at least partially transparent layer of the conveyed security insert by means of a beam of laser light so as to produce at least one optically detectable indicia which is partially overlaid by the at least one tactilely detectable indicia, the blackenings reflecting infrared light and visible light and/or UV light, and wherein
the beam of laser light is refracted by the lacquer coating during the manufacture of the safety insert at least in an edge region of the tactilely detectable mark, and
a printing device arranged and adapted to apply an ink coating which reflects visible light and which is transparent to infrared light and/or to ultraviolet light to a layer of the conveyed security insert.

11. The apparatus of claim 10, further comprising:
a first UV curing device arranged and constructed to cure by means of UV light the coating applied to a layer of the conveyed safety insert, and/or a printing device arranged and constructed for this purpose, and/or
a second UV curing device arranged and adapted to cure by means of UV light the ink coating applied to a layer of the conveyed safety liner, and/or
a lamination device arranged and adapted to bond together layers of the security insert.
